(19) United States
(12) Patent Application Publication
(10) Pub. No.: US 2006/0212459 A1
(43) Pub. Date: Sep. 21, 2006

(54) Website analysis system

(75) Inventor: Masahiko Sugimura, Kawasaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/191,988

(22) Filed: Jul. 29, 2005

(30) Foreign Application Priority Data
Mar. 18, 2005 (JP) 2005-079823

(51) Int. Cl. G06F 7/00

(52) U.S. Cl. 707/100

(57) ABSTRACT

A website analysis system is provided, which is capable of digitizing an effect of “attractiveness of contents or functions for collecting customers” on an access tendency of a user, separately from effects of other elements, based on aggregation results of an access log. The website analysis system includes an aggregating part for dividing log data during an aggregation period in an access log into log data groups in accordance with an aggregation granularity, and obtaining at least an access frequency and an access amount as an index value representing an access state on a user basis with respect to each of the log data groups; and a determining part for comparing the index value obtained by the aggregating part with a boundary condition, thereby calculating an index analysis value representing an effect of contents or functions for collecting customers of a website on an access tendency of a user.

### BACKGROUND OF THE INVENTION

1. Field of the Invention

The present invention relates to a website analysis system for evaluating and analyzing a website in terms of a marketing effect, usability, and the like by analyzing an access log of a website.

2. Description of Related Art

Along with the recent development of Internet-related technology, the promotion of goods and service and the sales of goods at a website have come to be performed generally. In order to effectively develop business using a website, it is important to successfully induce consumers using the Internet to a website of its own, as well as to enhance the attractiveness of goods and service.

Under the above-mentioned circumstance, in order to induce consumers to the website of its own, various ideas are being produced, for example, in the advertisement via other media (TV broadcast, newspaper, magazine, etc.), and banner advertisement displayed at another website on the Internet. Furthermore, as other measures for forcefully inducing consumers to the website of its own, various procedures are being attempted even with respect to so-called search engine optimization (SEO) in which an attempt is made so as to display the website of its own at an upper position of search results in a search engine used as a portal site.

It is also an important element for developing business using a website to enrich the contents or functions of a website so that a consumer who has accessed a website desires to browse through the website completely, and desires to access the website again. For example, in most cases, contents or functions for collecting customers, suiting the taste of potential customers of products and service of its own, such as cooking recipe contents (or a site) of a seasoning company or executive enlightenment contents (or a site) of a System Integrator (SI) company, are provided with no charge, and mass-marketing is deployed therein. In this case, generally, potential customers are collected to a website, and induced to a sales channel (a shop, a person in charge of sales, or a commerce site). Customer information is collected by introducing a membership system.

Thus, as factors for success of business using a website, there are complex elements such as “attractiveness of goods (service)”, “attractiveness of advertisement”, “effect of search engine optimization”, and “attractiveness of contents or functions”. In order to promote business using a website, it is necessary to appropriately grasp which point of these elements should be enhanced at a website of its own, and take appropriate measures.

In terms of the above, in order to obtain information on a visitor to a website to enhance the results of website administration, an access log obtained at a web server or a client terminal has been used conventionally.

For example, JP 11(1999)-312177 A discloses an apparatus that uses a log obtained by a browser of a client to quantitatively measure which site is used frequently by a user of the browser.

Furthermore, JP 2000-311124 A discloses that the granularity (time unit) of access aggregation is regulated in accordance with the access frequency and the access request amount with respect to a web server.

Furthermore, JP 2002-24127 A discloses a system in which, in the case where there are simultaneous accesses from the same IP address by a plurality of users, individual users are made identifiable, whereby accurate statistic information on the number of accesses is obtained.

In the conventional access log analysis including the examples disclosed in the above-mentioned respective patent documents, the following items are generally used frequently as an index for measuring the effect of a website.

(1) The total number of accesses during a predetermined period of time.

(2) The total number of reference pages at one visit.

(3) The number of arrivals during a predetermined period of time.

The number of arrivals (3) refers to the number of users who have arrived at a page to which users are desired to be induced finally at a website. The page to which users are desired to be induced finally refers to, for example, a page of “completion of order”, a page of “completion of information request”, and a page of “completion of membership registration”.

### SUMMARY OF THE INVENTION

However, the total number of accesses (1) is a numerical value representing the synergistic effect of elements such as “attractiveness of goods (service)”, “attractiveness of advertisement”, “attractiveness of contents or functions”, and “effect of search engine optimization”, and it is impossible to isolate the contribution of the effect of only the “attractiveness of contents or functions”, for example. Furthermore, the total number of reference pages (2) is a numerical value representing the synergistic effect of the “attractiveness of goods (service)” and the “attractiveness of contents or functions”, and it is impossible to isolate the contributions of the respective effects. This also applies to (3).

Thus, according to the prior art, it is impossible to digitize the effect of only the “attractiveness of contents or functions” at a website based on an access log.

Therefore, with the foregoing in mind, it is an object of the present invention to provide a website analysis system capable of digitizing the effect of “attractiveness of contents or functions” of a website on the access tendency of a user, separately from the effects of other elements such as “attractiveness of goods (service)”, “attractiveness of advertisement”, and “effect of search engine optimization”, based on aggregation results of an access log.

In order to achieve the above-mentioned object, a website analysis system according to the present invention includes: an aggregating part for dividing log data during an aggregation period in an access log into log data groups in accordance with an aggregation granularity, and obtaining at least an access frequency and an access amount as an index value representing an access state on a user basis with respect to each of the log data groups; and a determining part for comparing the index value obtained by the aggregating art with a boundary condition, thereby calculating an index analysis value representing an effect of contents or functions of a website on an access tendency of a user.

According to the above configuration, the aggregating part aggregates access logs, thereby obtaining at least an access frequency and an access amount as an index value representing an access state on a user basis. Then, the determining part compares the index value obtained by the aggregating part with a boundary condition, thereby calculating, as a numerical value, an index analysis value representing an effect of contents or functions of a website on an access tendency of a user. An index analysis value is calculated from the index value including at least the access frequency and the access amount, whereby the effect of the “attractiveness of contents or functions” of the website on the access tendency of a user can be digitized, separately from the effects of other elements such as “attractiveness of goods (service)”, “attractiveness of advertisement”, and “effect of search engine optimization”. Because of the above, the precision of an index for evaluating a user who has accessed the website can be enhanced, and in particular, a repeater at the website can be evaluated appropriately. The attractiveness of the website can be evaluated purely as well.

In the website analysis system according to the present invention, it is preferable that the aggregating part determines a plurality of log data continuous at an interval within a predetermined period of time, which are ascribed to a request from the same user, to be one session in the log data groups, and sets the number of the sessions in the log data groups to be an access frequency of the user.

According to the above configuration, the number of sessions included in the log data groups corresponding to the aggregation granularity is used as an access frequency. One session refers to the collection of a series of log data ascribed to a continuous operation of the same user. Therefore, an index value reflecting the access state of a user more exactly can be obtained with respect to an access frequency, compared with the case of simply using the number of log data as an access frequency. Accesses involved in a series of operations by a user can be counted as one session.

In the website analysis system according to the present invention, it is preferable that the aggregating part aggregates log data ascribed to a request from the same user by dividing an aggregation granularity into a plurality of sections in the log data groups, and sets the number of sections in which the log data are present to be an access frequency of the user.

According to the above configuration, for example, in the case where a user repeats frequent accesses in a concentrated manner only in a very short period of time of the aggregation granularity, an index value reflecting the access state of the user more exactly can be obtained with respect to an access frequency, compared with the case of simply using the number of log data as an access frequency.

In the website analysis system according to the present invention, it is preferable that the aggregating part aggregates the number of log data ascribed to a request from the same user respectively in the log data groups, and obtaining an access amount of each user based on aggregation results.

As the access amount, the number of the log data aggregated on the user basis may be used directly, or a value obtained by dividing the number of log data aggregated on the user basis by an access frequency may be used. In the website analysis system according to the present invention, as the boundary condition, predetermined values respectively determined with respect to the access frequency and the access amount, or a linear function of the access frequency and the access amount can be used.

### BRIEF DESCRIPTION OF THE DRAWINGS

FIG. 1 is a block diagram showing a schematic configuration of a website analysis system according to one embodiment of the present invention.

FIG. 2 is a flow chart showing an operation summary of the website analysis system according to one embodiment of the present invention.

FIG. 3 shows a format example of log data to be analyzed by the website analysis system according to one embodiment of the present invention.

FIG. 4 is a flow chart showing an example of the detailed procedure of Operation Op 14 (aggregation processing) shown in FIG. 2.

FIG. 5 shows an example of log data during aggregation processing.

FIG. 6 schematically shows an example of determination processing in the website analysis system according to one embodiment of the present invention.

FIG. 7 is an example of a graph displayed as analysis results in the website analysis system according to one embodiment of the present invention.

FIG. 8 shows another display embodiment of analysis results in the website analysis system according to one embodiment of the present invention.

FIG. 9 shows still another display embodiment of analysis results in the website analysis system according to one embodiment of the present invention.

FIG. 10 is a flow chart showing another example of the detailed procedure of Operation Op 14 (aggregation processing) shown in FIG. 2.

FIG. 11 shows a specific example of aggregation processing shown in FIG. 10.

FIG. 12 schematically shows another example of determination processing in the website analysis system according to one embodiment of the present invention.

FIG. 13 schematically shows still another example of the determination processing in the website analysis system according to one embodiment of the present invention.

FIG. 14 schematically shows still another example of the determination processing in the website analysis system according to one embodiment of the present invention.

FIG. 15 shows still another display embodiment of the analysis result in the website analysis system according to one embodiment of the present invention.

### DETAILED DESCRIPTION OF THE INVENTION

Hereinafter, the present invention will be described more specifically by way of an illustrative embodiment with reference to the drawings.

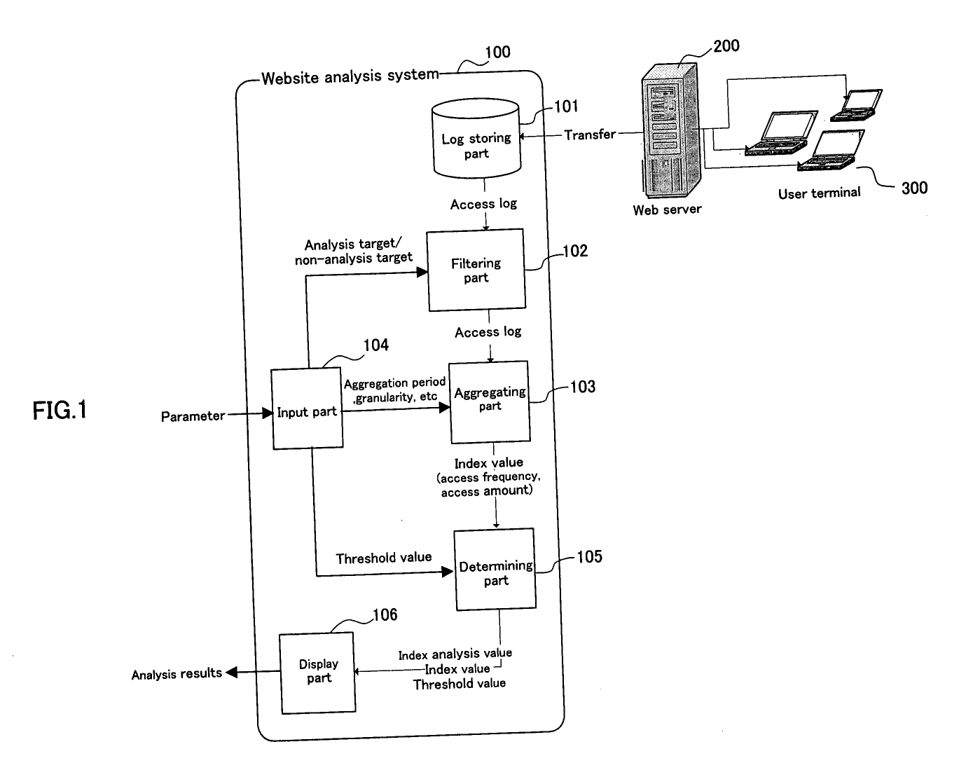

FIG. 1 is a block diagram showing a schematic configuration of a website analysis system 100 according to one embodiment of the present invention.

The website analysis system 100 according to the present embodiment measures “attractiveness of contents or functions for collecting customers” of a website by receiving and analyzing an access log from a web server 200 on the Internet. The website analysis system 100 is implemented by a server or a personal computer.

The access log may be transmitted/received between the web server 200 and the website analysis system 100 on-line or off-line via a recording medium. Furthermore, in the case where the access log is transmitted/received on-line, log data may be transferred successively, or log data of a predetermined period of time or a predetermined amount may be transferred collectively.

The website analysis system 100 includes a log storing part 101, a filtering part 102, an aggregating part 103, an input part 104, a determining part 105, and a display part 106. The log storing part 101 stores an access log transferred from the web server 200 at least temporarily, and is composed of, for example, a storage apparatus such as a hard disk.

The filtering part 102 removes unnecessary log data from an access log so as to facilitate analysis. An analyzer can input which log data is to be analyzed and which log data is not to be analyzed as a parameter from the input part 104. The removal processing of log data by the filtering part 102 will be described later. The access log of processing results by the filtering part 102 is transmitted to the aggregating part 103.

The input part 104 allows the analyzer to input a parameter regarding an aggregation period, an aggregation granularity, etc., a parameter representing a boundary condition, and the like, in addition to the parameter regarding log data to be analyzed or log data not to be analyzed (non-analysis target log data). The parameter regarding the aggregation period designates the period of log data to be analyzed. Although the parameter regarding the aggregation period generally designates aggregation start date and time, and the length of an aggregation period (e.g., one week, one month, one year, etc.), the present invention is not limited thereto. The parameter regarding the aggregation granularity represents the width of an observation point for measuring the tendency of an access state of users during an aggregation period. For example, if the aggregation period is one year, assuming that the aggregation granularity is one month, for example, the tendency of an access state of users can be measured based on 12 observation points by aggregating log data on a one-month basis.

The aggregating part 103 aggregates the access logs received from the filtering part 102, and calculates an index value (access frequency) representing how frequently each user visits the website to be analyzed, and an index value (access amount) representing how deeply each user refers to the website to be analyzed. The tendency of users with respect to the website to be analyzed can be grasped based on these index values. The aggregation results obtained by the aggregating part 103 are given to the determining part 105.

The determining part 105 compares the aggregation results (index values) of the aggregating part 103 with predetermined threshold values, thereby obtaining analysis results (index analysis value) as a numerical value.

The obtained analysis results are given from the determining part 105 to the display part 106. The display part 106 processes the analysis results into a form (e.g., a graph) to be easily recognized by a human. In the present embodiment, the means for presenting analysis results is set to be a display part. However, the presentation of analysis results is not limited to a display on a display part, and may be printed out.

Next, the website analysis processing by the website analysis system 100 with the above-mentioned configuration will be described in detail with reference to the drawings.

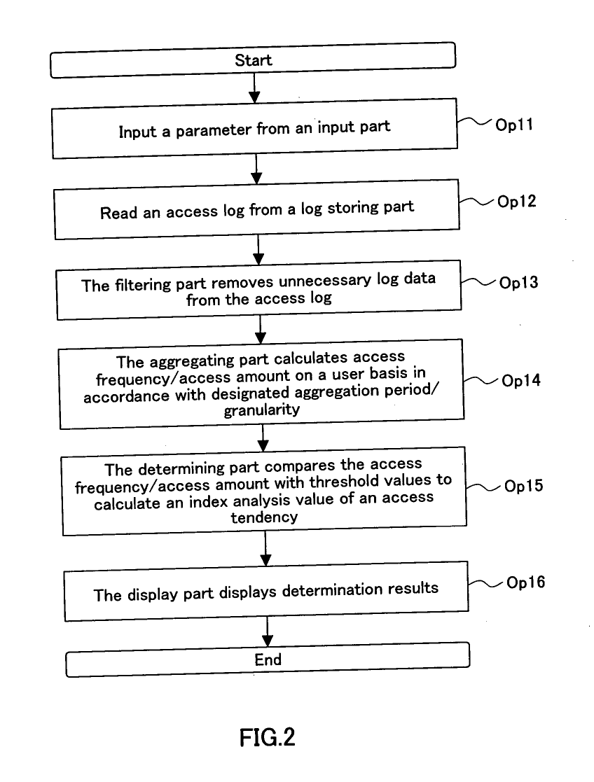

FIG. 2 is a flow chart showing a summary of website analysis processing by the website analysis system 100. As shown in FIG. 2, the website analysis system 100 first receives parameters inputted by an analyzer from the input part 104 (Operation Op 11). A parameter regarding log data to be analyzed (or not to be analyzed) among the parameters inputted in Operation Op 11 is referred to by the filtering part 102. Furthermore, a parameter regarding the aggregation such as an aggregation period and an aggregation granularity is referred to by the aggregating part 103, and a parameter regarding the determination of a threshold value or the like is referred to by the determining part 105.

Next, an access log is taken out from the log storing part 101 (Operation Op 12), and given to the filtering part 102. The filtering part 102 refers to a parameter regarding the log data to be analyzed (or not to be analyzed) inputted in Operation Op 11, and removes unnecessary log data during aggregation from a text file of an access log (Operation Op 13).

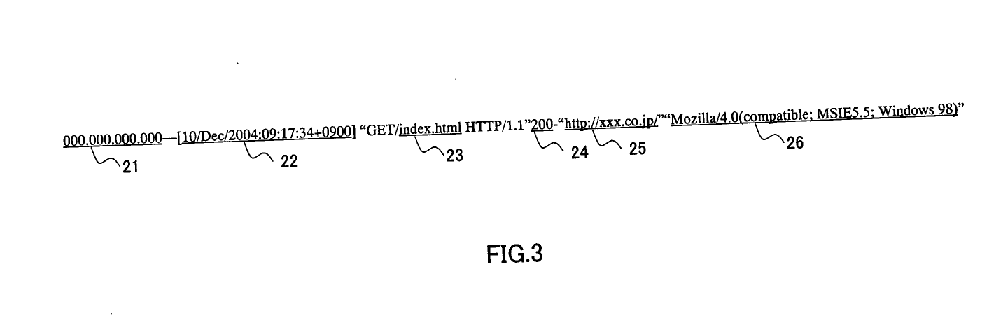

Hereinafter, the log data of the access log will be described with reference to FIG. 3, in connection with the processing by the filtering part 102 in Operation Op 13. The access log is a text file composed of log data. Every time there is an access from the user terminal 300 to the web server 200, one log data is generated in the web server 200.

More specifically, when a user clicks on a link to a website provided by the web server 200 on a browser of the user terminal 300, a request (HTML request) to an HTML file is transmitted from the browser to the web server 200. The web server 200 generates one log data regarding this HTML request. Then, in the case where there is a link to an image in the HTML, a request (image request) to an image file is further transmitted from the browser to the web server 200. The web server 200 generates one log data even regarding the image request.

Thus, in the case where there are a plurality of images in a page, log data corresponding to the number of images are generated. Thus, an image request and the like are generated necessarily along with the access to a page containing an image. Consequently, when log data regarding an image request and the like is not to be analyzed, the precision of analysis is enhanced. It is preferable that the analyzer designates log data regarding the HTML request as an analysis target, and designates log data regarding other requests image request, etc.) as a non-analysis target.

The analyzer can appropriately set which log data is to be analyzed (or not to be analyzed) with the input part 104, if required. In general, as log data that is effective as an analysis target other than log data regarding the HTML request, there is log data regarding a request for dynamically generating an HTML in which an extension contains a file name such as “.cgi” or “.jsp”. On the other hand, as log data that is effective as a non-analysis target, there are log data in which an HTTP state code 24 is not a normal finish code, log data regarding a request to a style sheet (an extension is “.css”), log data regarding a request to a javascript file (an extension is “.js”), and the like, in addition to the above-mentioned log data regarding an image request.

As shown in FIG. 3, the log data contains a client name 21 of the user terminal 300 that has accessed, an access date and time 22, a requested file name 23, the HTTP state code 24, a referrer 25 representing a URL of a page of an access origin, user environment data 26 representing an environment of the user terminal 300, and the like.

In the case where a name resolution (so-called “backward look-up”) from an IP address can be performed, the client name 21 is represented by a domain name of the user terminal 300. Thus, for example, in the case of analyzing a website at which the promotion targeted for corporations is being performed, it is also effective for enhancing an analysis precision to set the log data, in which the client name 21 is not a corporation domain (e.g., “co.jp”), not to be analyzed. On the other hand, in the case where a name resolution cannot be performed, and the like, the client name 21 is represented as an IP address. Furthermore, in the case of using a cookie so as to exactly specify a user, the information on the cookie is also included in the log data.

FIG. 3 illustrates the log data containing the referrer 25 and the user environment data 26. However, in the present embodiment, the referrer 25 and the user environment data 26 are not necessary for analysis. Therefore, as long as another analysis based on these data is not required, the referrer 25 or the user environment data 26 may not be obtained in the web server 200 so as to reduce the volume of an access log.

Furthermore, FIG. 3 shows an example of log data by Apache that is most widely spread today as web server software. However, the form of log data should not be limited to only the specific example shown in FIG. 3. The contents of data included in log data and the format of the log data are varied arbitrarily in accordance with the kind of web server software forming the web server 200, and setting contents of operation parameters in the software.

It can be determined which kind of file the request from the user terminal 300 is targeted for, based on the extension of the file name 23 in the log data. Thus, for example, in the case where it is desired that the log data regarding an image request is not to be analyzed, the analyzer inputs an extension (“.gif”, etc.) of an image file as a parameter from the input part 104. The filtering part 102 refers to this parameter, and removes the log data in which the extension designated by the analyzer is included in the file name 23 from the access log.

In addition, it is preferable that log data not corresponding to a request ascribed to the attractiveness of contents or functions for collecting customers of a website is removed from an analysis target. The analyzer can input, as a parameter, a file name of a file that is considered not to contribute to the attractiveness of contents or functions for collecting customers of a website. The filtering part 102 refers to this parameter, and removes the log data in which the file name designated by the analyzer is included in the file name 23 from the access log. In the web server 200, files are generally stored under the condition of being classified in directories. In this case, a directory name is included in the file name 23 in the log data. Thus, the analyzer may input a directory name in place of a file name from the input part 104 as a parameter.

Only the condition of log data desired to be an analysts target may be input from the input part 104 with a parameter, in place of inputting the condition of log data desired not to be an analysis target from the input part 104 with a parameter. For example, in the case where only the log data regarding the HTML request is desired to be an analysis target, the analyzer inputs an extension (“.htm”, etc.) of the HTML file from the input part 104 as a parameter. In this case, the filtering part 102 refers to this parameter, leaves only the log data in which the extension of the HTML file is included in the file name 23, and removes the other log data from the access log.

Similarly, the analyzer may input a file name and a directory name, which are considered to be factors for the attractiveness of contents or functions for collecting customers of a website, from the input part 104.

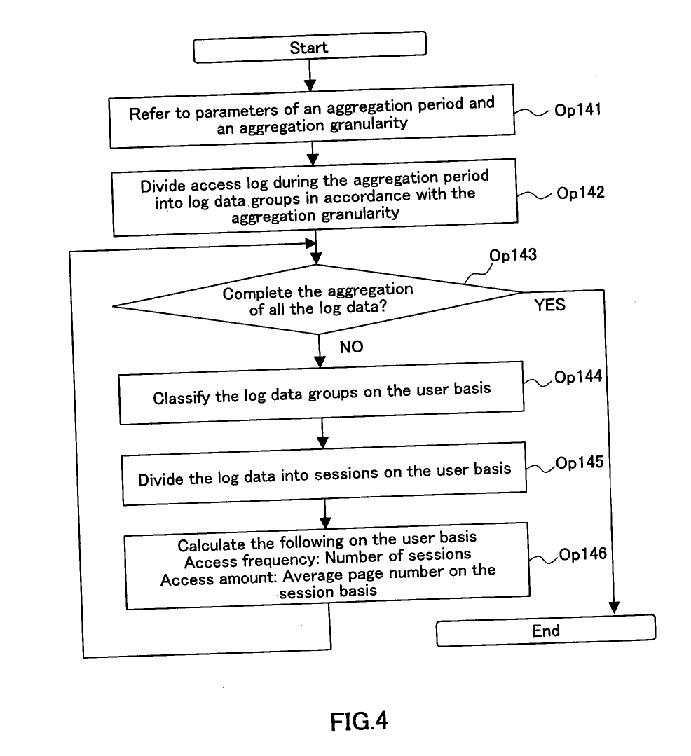

As described above, the access log in which unnecessary log data is removed in the filtering part 102 is transmitted to the aggregating part 103 for aggregation (Operation Op 14 in FIG. 2). Herein, an example of processing in the aggregating part 103 in Operation Op 14 will be described with reference to FIG. 4.

FIG. 4 is a flow chart showing an example of aggregation processing in the aggregating part 103. As shown in FIG. 4, the aggregating part 103 first refers to parameters of the “aggregation period” and the “aggregation granularity” inputted from the input part 104 (Operation Op 141). Herein, it is assumed that the analyzer has designated “one year” from a particular date and time as the “aggregation period” and “one month” as the “aggregation granularity” through parameter input from the input part 104.

The aggregating part 103 extracts log data of one year from the particular date and time among the log data received from the filtering part 102 in accordance with this designation, and divides the extracted log data into log data groups on a one-month basis (Operation Op 142).

The aggregating part 103 repeats Operations Op 144 to Op 146 described below until the processing is completed (YES in Operation Op 143) with respect to all the log data groups divided on a one-month basis.

In Operation Op 144, the aggregating part 103 classifies the log data of one month on the client name 21 basis of the log data (Operation Op 144).

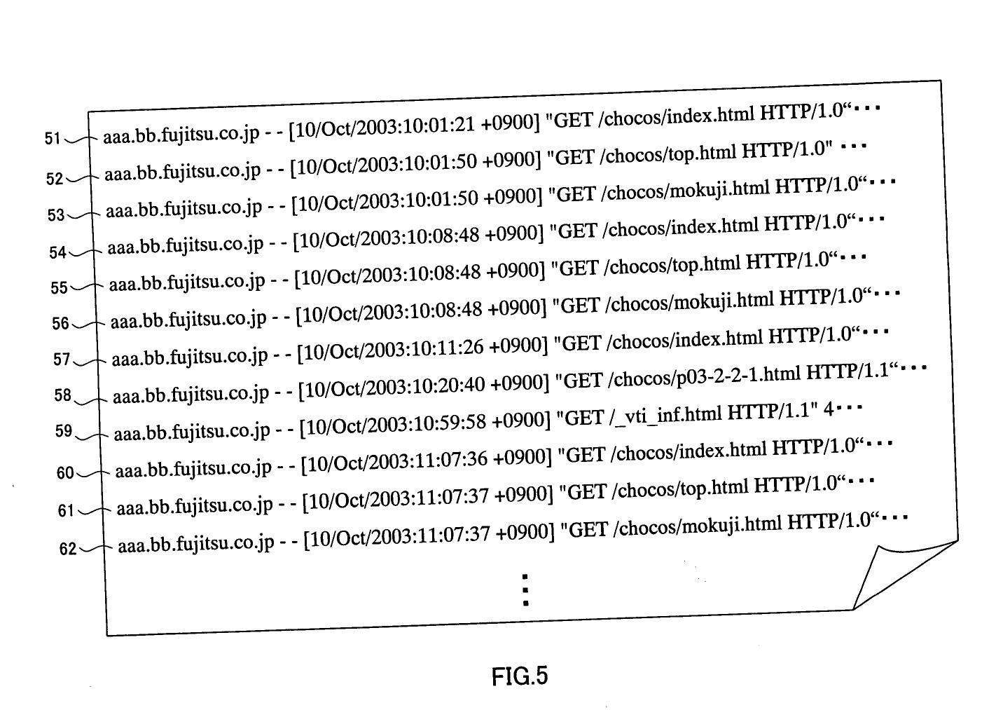

In Operation Op 144, the aggregating part 103 classifies the log data having the same client name 21 so that they are arranged in the order of an access date and time 22. FIG. 5 shows an example of the log data thus classified. In FIG. 5, in order to simplify the figure, the HTTP state code 24, the referrer 25, the user environment data 26, and the like of each log data are omitted.

Next, in Operation Op 145, the aggregating part 103 divides the collection of log data having the same client name 21 into sessions. The session refers to the collection of log data ascribed to the continuous operation by the same user, i.e., the collection of log data generated without a long interval. Herein, the aggregating part 103 determines that all the log data in which an interval of a time represented by the access date and time 22 is, for example, within 30 minutes are included in one session. On the other hand, log data in which the time represented by the access date and time 22 is 30 minutes or longer from the time represented by the access date and time 22 of the previous log data belongs to a session different from that of the previous log data.

In the example shown in FIG. 5, the difference between the time represented by the access date and time 22 of each of log data 52 to 58, and the time represented by the access date and time 22 of the previous log data of each of the log data 52 to 58 is within 30 minutes. Therefore, log data 51 to 58 are determined to belong to one session. Furthermore, the time difference in the access date and time 22 between the log data 58 and log data 59 is 30 minutes or longer. Therefore, the log data 59 is considered as the commencement of a new session. Thus, the log data 59 to 62 are considered to belong to one session next to the log data 51 to 58.

The standard of session division in Operation Op 145 is not limited to the above condition of whether or not the difference in access date and time with respect to the previous log data is within a predetermined period of time. For example, even if the difference in access date and time is within a predetermined period of time, in the case where the transition of the referrer 25 of the log data is paid attention to, and an second access after the referrer 25 moves to another website is recognized, this second access may be considered as the commencement of a new session.

Next, the aggregating part 103 counts the number of sessions obtained by the session division in Operation Op 145 on the basis of a log data group having the same client name 21 (i.e., on the user basis), and sets the count results as “access frequency” of the user. Similarly, the aggregating part 103 counts the number of log data forming each session (i.e., the number of web pages referred to by the user in the session) on the basis of log data having the same client name 21 (i.e., on the user basis), obtains an average value thereof, and sets it as “access amount” of the user (Operation Op 146). The access frequency and access amount obtained in Operation Op 146 are stored in a memory or the like.

When the above-mentioned Operations Op 144 to Op 146 are repeated until the processing is completed with respect to all the log data groups divided on a one-month basis (YES in Operation Op 143), the aggregating part 103 gives the results of the aggregation processing to the determining part 105. More specifically, the determining part 105 receives the access frequency and the access amount on the user basis during the aggregation period (one year herein) aggregated on the basis of an aggregation granularity (one month herein) as the results of aggregation processing by the aggregating part 103. In this example, the user is represented by the client name 21 (domain name or IP address) in log data.

The determining part 105 compares the access frequency and the access amount of each user with the threshold value with respect to the access frequency and the threshold value with respect to the access amount inputted from the input part 104 (Operation Op 15 in FIG. 2). The analyzer can arbitrarily input the threshold value with respect to the access frequency as, for example, “4”, and the threshold value with respect to the access amount as, for example, “6” from the input part 104. These numerical values are shown merely for an illustrative purpose. In Operation Op 15, the determining part 105 obtains the number of users in which both the access frequency and the access amount exceed the respective threshold values on the basis of the aggregation granularity (one month herein). More specifically, as shown in FIG. 6, the determining part 105 divides a two-dimensional space represented by an access frequency (F) and an access amount (V) into four regions 71 to 74 with a threshold value (Ft) of the access frequency and a threshold value (Vt) of the access amount, and obtains the number of users belonging to a region 71 where F>Ft and V>Vt. Black dots shown in FIG. 6 are index values (F, V) of the respective users in the two-dimensional space represented by the access frequency (F) and the access amount (V). The determining part 105 allows the display part 106 to display determination results.

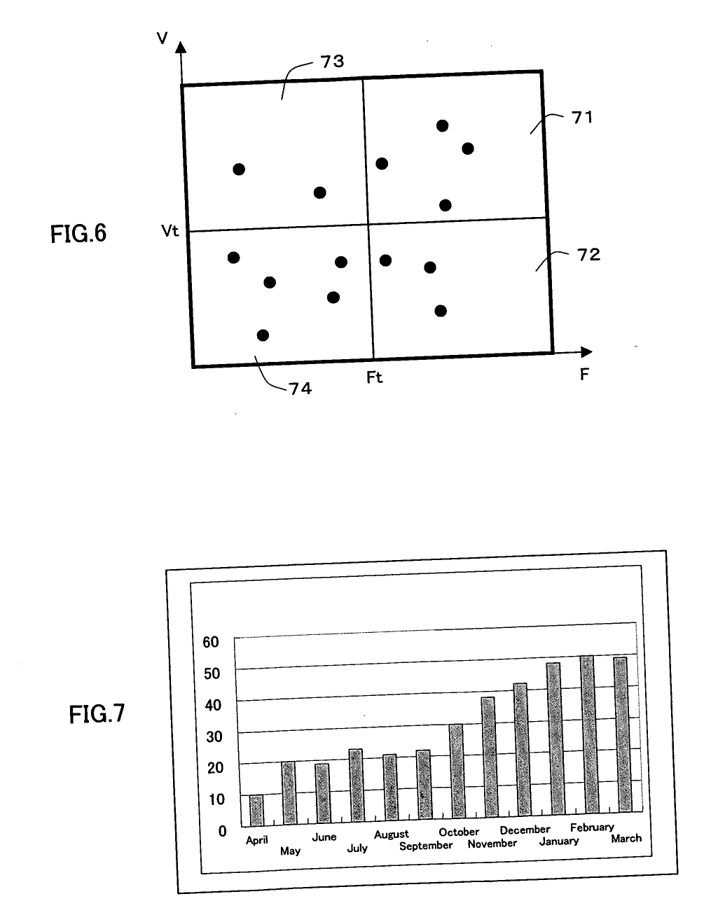

FIG. 7 illustrates an example of a state where the display part 106 displays the determination results obtained by the determining part 105 in a graph. In the example shown in FIG. 7, the transition of the number of users in which both the access frequency and the access amount exceed the threshold values is displayed over the aggregation period (one year) on the aggregation granularity (one month) basis. This display realistically shows the tendency of users who access a website frequently, and refer to the website deeply. That is, the tendency of the users owing to the effect of the “attractiveness of contents or functions for collecting customers” of the website can be evaluated exactly.

For example, in the example shown in FIG. 7, when the contents of the website are renewed so as to be matched with the needs of customers in around September, the number of users in which both the access frequency and the access amount exceed the threshold values increase remarkably in October. Thus, the analyzer can confirm the effect of the renewed contents from the analysis results. Furthermore, the number of users in which both the access frequency and the access amount exceed the threshold values is stable after January. Thus, the analyzer can determine that the administration form of the website may be changed to a registration system site since the number of such users have increased sufficiently.

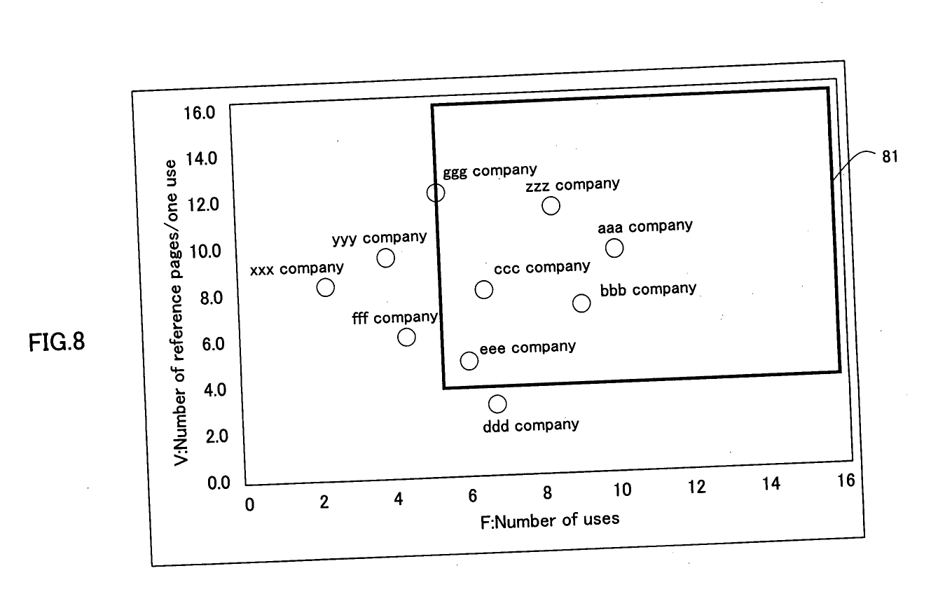

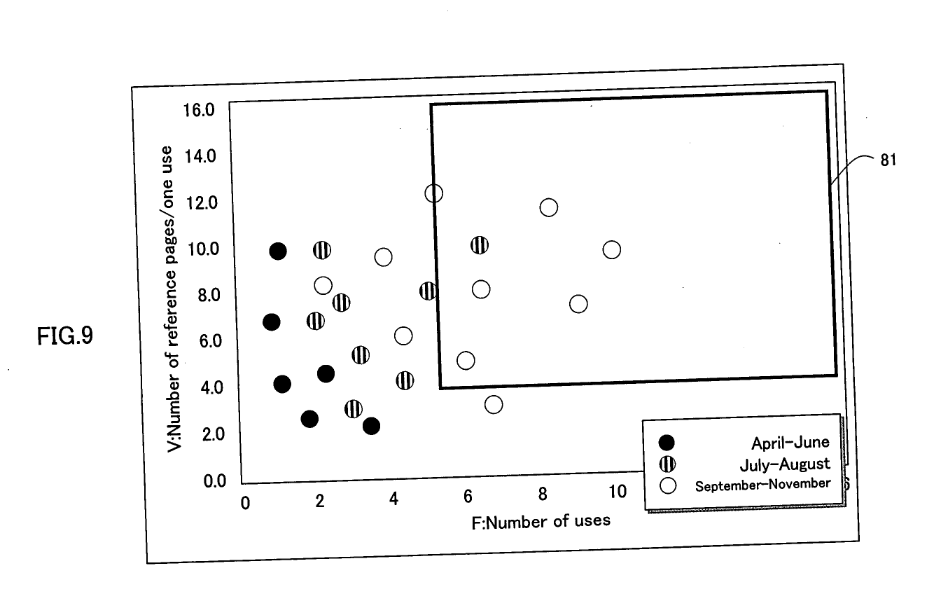

Furthermore, the display form in the display part 106 may be the mapping of users in the two-dimensional space represented by the access frequency (F) and the access amount (v), as shown in FIG. 8. In this case, a display form is preferable in which a boundary condition can be visually recognized by giving information on the boundary condition (threshold value) from the determining part 105 to the display part 106. In the example shown in FIG. 8, the region where F>Ft and V>Vt, surrounded by a frame 81, is displayed in the displayed two-dimensional space. Furthermore, as shown in FIG. 8, there is an advantage that if the client name 21 of a user, a user name (e.g., a company name) determined from the client name 21, and the like are displayed, the analyzer can easily specify a user. Furthermore, as shown in FIG. 9, a display form may be used in which the tendency of an access state of users during the aggregation period is understood under the condition that users are mapped in the two-dimensional space.

As described above, in the website analysis system 100 according to the present embodiment, the analyzer can exactly grasp the tendency of users owing to the effect of the “attractiveness of contents or functions for collecting customers” of a website, based on the number of users in which both the access frequency and the access amount exceed the threshold values.

The above-mentioned specific example is merely a preferable embodiment of the website analysis system according to the present invention, and the specific method of aggregation in the aggregating part 103 and the specific method of determination in the determining part 105 can be variously changed.

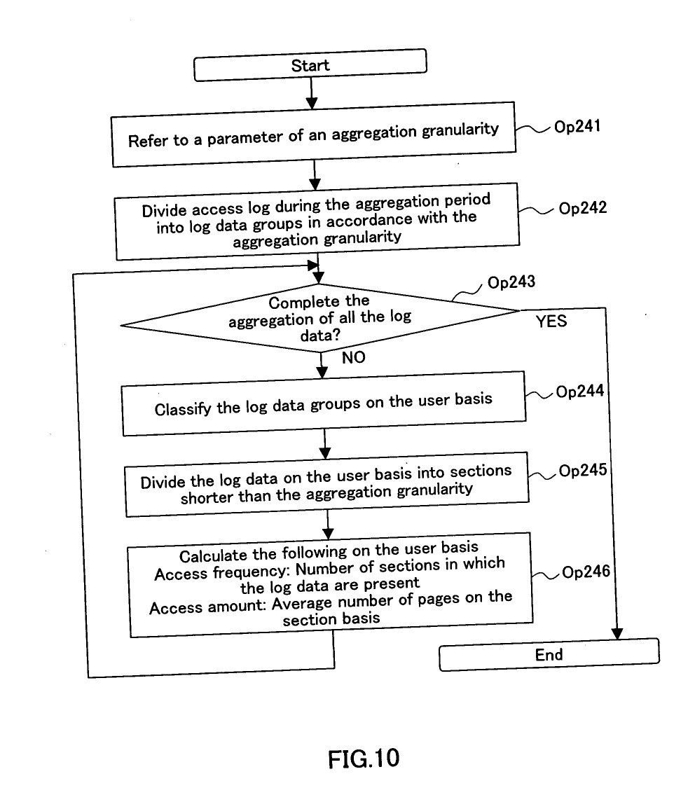

As an example, FIG. 10 shows another embodiment of the aggregation processing (Operation Op 14 in FIG. 2) in the aggregating part 103. More specifically, the procedure shown in FIG. 10 is an alternative procedure of the one shown in FIG. 4. According to the procedure shown in FIG. 10, the aggregating part 103 refers to the parameters “aggregation period” and “aggregation granularity” inputted from the input part 104 (Operation Op241). Herein, it is assumed that “one year” and “one month” are designated by the analyzer as the “aggregation period” and the “aggregation granularity”, respectively. The aggregating part 103 divides the log data of the past one year among the log data received from the filtering part 102 on a one-month basis in accordance with the analyzer's designation (Operation Op242). The start date of the aggregation period may be allowed to be arbitrarily designated through parameter input from the input part 104.

The aggregating part 103 repeats Operations Op244 to Op246 described below until the processing is completed with respect to all the log data groups divided on a one-month basis (YES in Operation Op243).

In Operation Op244, the aggregating part 103 classifies the log data of one month on the client name 21 basis of the log data (Operation Op244).

In Operation Op244, the aggregating part 103 classifies the log data having the same client name 21 so that they are arranged in the order of the access date and time 22.

Next, the aggregating part 103 divides the collection of the log data having the same client name 21 into sections (e.g., one week) shorter than the aggregation granularity (one month herein) in accordance with the access date and time 22 (Operation Op245). The length of this section can also be arbitrarily designated by the analyzer from the input part 104.

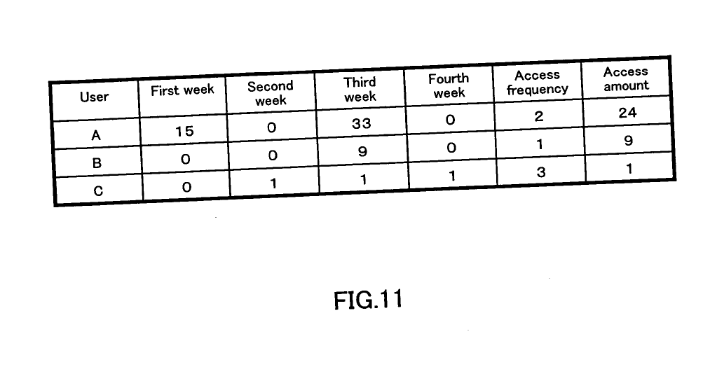

The aggregating part 103 calculates the access frequency of each user as the number of sections in which the log data are present (Operation Op246). For example, it is assumed that the number of the log data in each section regarding users A, B, and C is as shown in FIG. 11. Regarding the 20 user A, there are log data having accessed the website on the first and third weeks, and there are no log data on the second and fourth weeks. In this case, the access frequency of the user A is 2. Furthermore, regarding the user B, there are log data only on the third week, so that the access frequency is 1. Similarly, the access frequency of the user C is 3.

Furthermore, in Operation Op246, the aggregating part 103 obtains an average value of the number of access pages (number of log data) in the above-mentioned respective sections on the basis of the log data groups (i.e., on the user basis) having the same client name 21, and sets the average value as the “access amount” of the concerned user (Operation Op247). For example, in the example shown in FIG. 11, (15+33)/2=24 becomes the access amount of the user A. The access frequency and the access amount obtained in Operation Op247 are stored in a memory or the like.

When the above-mentioned Operations Op244 to Op247 are repeated until all the log data groups divided on a one-month basis is completed (YES in Operation Op243), the aggregating part 103 give the results of the aggregation processing to the determining part 105.

As described above, even according to the procedure shown in FIG. 10, the access frequency and the access amount as index values reflecting the effect of the “attractiveness of contents or functions for collecting customers” of the website can be calculated. Furthermore, according to the procedure shown in FIG. 10, compared with the procedure shown in FIG. 4, an index value containing “whether or not the access to the website by each user is constant” as an evaluation element is obtained.

Furthermore, as still another embodiment of the aggregation processing (Operation Op 14 in FIG. 2) in the aggregating part 103, the “access frequency” is obtained from the variance of the access date and time instead of the number of sessions.

Furthermore, in the above-mentioned description, as the index value obtained by the determining part 105, the number of users belonging to a region where F>Ft and V>Vt has been illustrated in the two-dimensional space represented by the access frequency (F) and the access amount (V), as shown in FIG. 6. However, the index value obtained by the determining part 105 is not limited to this example, and at least following index values can be used preferably.

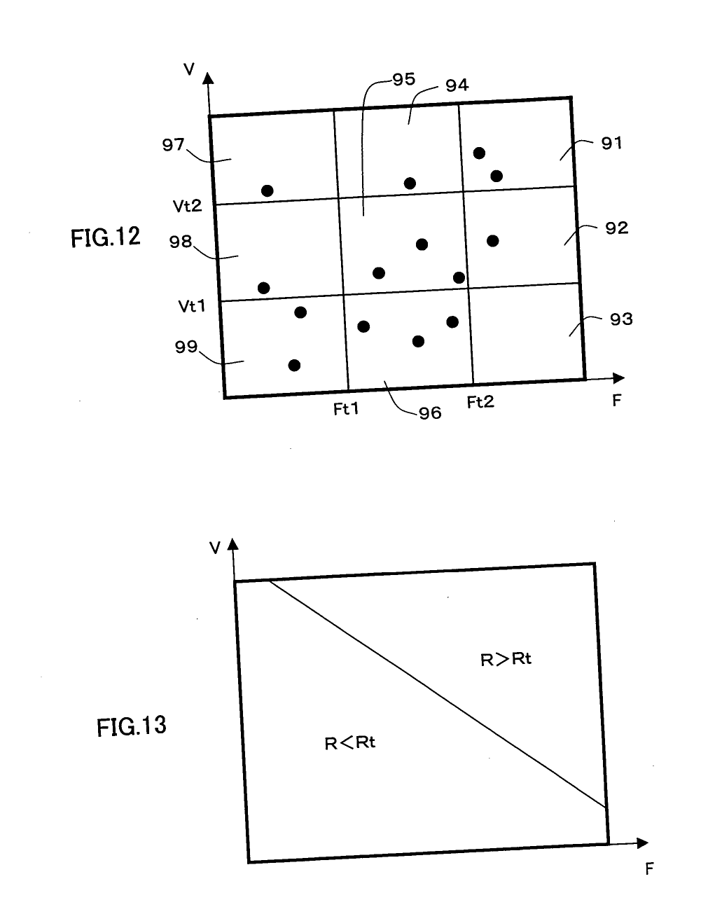

For example, a plurality of threshold values may be set with respect to at least one of the access frequency (F) and the access amount (V). More specifically, as shown in FIG. 12, the determining part 105 may calculate, as an index value, the number of users belonging to a region 91 where F>Ft2 and V>Vt 2. In the example shown in FIG. 12, users can be classified into 9 kinds, depending upon the degree of the access frequency and the access amount.

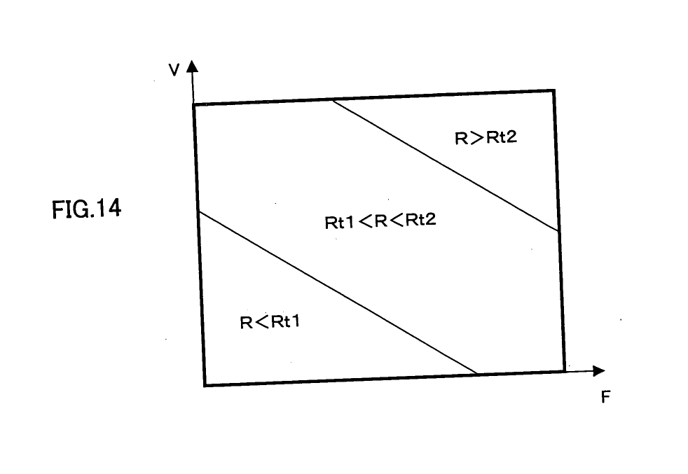

Furthermore, the boundary condition used by the determining part 105 is not limited predetermined threshold values regarding the access frequency and the access amount. For example, as shown in FIG. 13, a linear function of the access frequency (F) and the access amount (V) may be used as the boundary condition. Specifically, R=a×F+b×V (a, b: constant), and the number of users in which the value of R exceeds a predetermined threshold value (Rt) may be calculated as an index value. Predetermined values may be previously set as the values of “a” and “b” in the determining part 105, and the analyzer may input an arbitrary numerical value as a parameter from the input part 104. Furthermore, in the example shown in FIG. 13, users are classified into two kinds. For example, if at least two kinds of threshold values of R (two kinds: Rt1 and Rt2 in FIG. 14) are provided as shown in FIG. 14, users can be classified into at least three kinds.

Furthermore, in the above-mentioned description, an example has been shown in which the number of users exceeding a predetermined boundary condition is used as an index analysis value representing the effect of the contents or functions for collecting customers of a website on the access tendency of users. However, the index analysis value is not limited to the number of users itself. For example, a ratio of the number of users exceeding the above-mentioned boundary condition with respect to the total number of users, or the like may be used as an index analysis value.

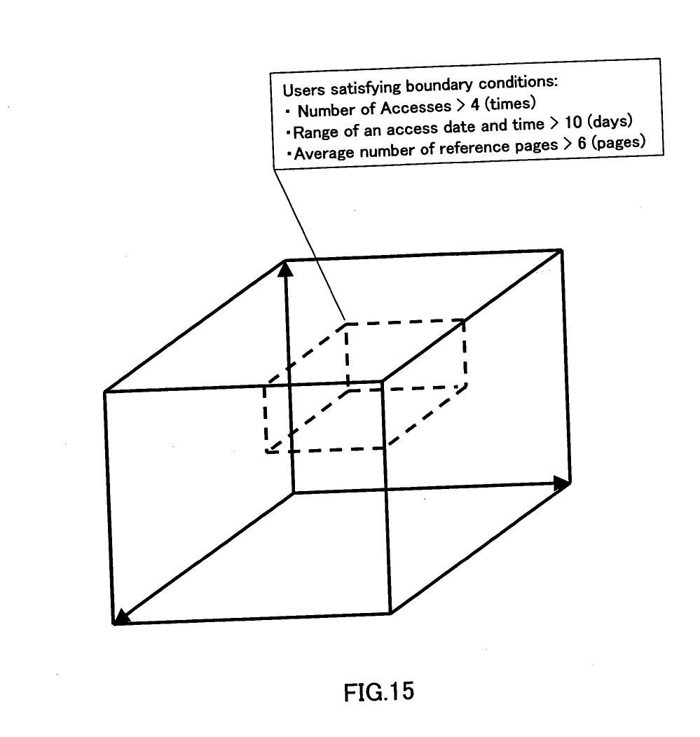

Furthermore, in the above-mentioned description, a configuration has been described in which both the access frequency and the access amount are obtained in the aggregating part 103 as index values representing the access state on a user basis. However, the aggregating part 103 may further obtain an index value other than the “access frequency” and the “access amount” as an index value representing the access state on the user basis. An example of such an index value includes “access continuity”. The “access continuity” is an index value representing how steadily each user accesses a website to be analyzed within an aggregation granularity (for example, one month). Thus, for example, the range of the access date and time 22 of log data, the variance or standard deviation of the access date and time 22, and the like can be used as an index value of the “access continuity”. Thus, in the case where there are three kinds of index values representing an access state on the user basis, it is preferable that the display part 106 displays users mapped in a pseudo three-dimensional space, as shown in FIG. 15.

In the above embodiment, an example of contents or functions for collecting customers has been described. However, the contents or functions to which the present invention is applicable are not limited for collecting customers. The present invention is applicable for pure evaluation with respect to arbitrary contents or functions.

The embodiment of the present invention is not limited to the website analysis system that is implemented by a server or a personal computer. A computer program that is read by a server or a personal computer and operates the server or the personal computer as the website analysis system according to the present invention, and a recording medium storing the computer program also are aspects of the present invention.

The present invention is applicable as a website analysis system capable of measuring the “attractiveness of contents or functions” separately from other elements.

According to the present invention, a website analysis system can be provided, which is capable of digitizing the effect of the “attractiveness of contents or functions” on the access tendency of a user, separately from the effects of the other elements, based on aggregation results of an access log.

Because of this, in particular, the precision of an index for evaluating a user who has accessed the website can be enhanced, and in particular, the degree of a repeater among users who have accessed the website can be determined exactly. In addition, the attractiveness of the website itself can be evaluated purely.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A website analysis system comprising:
an aggregating part for dividing log data during an aggregation period in an access log into log data groups in accordance with an aggregation granularity, and obtaining at least an access frequency and an access amount as an index value representing an access state on a user basis with respect to each of the log data groups; and
a determining part for comparing the index value obtained by the aggregating part with a boundary condition, thereby calculating an index analysis value representing an effect of contents or functions of a website on an access tendency of a user.

2. The website analysis system according to claim 1, wherein the aggregating part determines a plurality of log data continuous at an interval within a predetermined period of time, which are ascribed to a request from the same user, to be one session in the log data groups, and sets the number of the sessions in the log data groups to be an access frequency of the user.

3. The website analysis system according to claim 1, wherein the aggregating part aggregates log data ascribed to a request from the same user by dividing an aggregation granularity into a plurality of sections in the log data groups, and sets the number of sections in which the log data are present to be an access frequency of the user.

4. The website analysis system according to claim 1, wherein the aggregating part aggregates the number of log data ascribed to a request from the same user respectively in the log data groups, and obtaining an access amount of each user based on aggregation results.

5. The website analysis system according to claim 1, wherein the boundary condition is a predetermined value determined with respect to each of the access frequency and the access amount, or a linear function of the access frequency and the access amount.

6. A recording medium storing a computer program for allowing a computer to execute:
aggregation processing of dividing log data during an aggregation period in an access log into log data groups in accordance with an aggregation granularity, and obtaining at least an access frequency and an access amount as an index value representing an access state on a user basis with respect to each of the log data groups; and
a determination processing for comparing the index value obtained by the aggregating part with a boundary condition, thereby calculating an index analysis value representing an effect of contents or functions of a website on an access tendency of a user.
